(19) United States
(12) Patent Application Publication
(10) Pub. No.: US 2025/0225458 A1
(43) Pub. Date: Jul. 10, 2025

(54) PRODUCTION SCHEDULING METHOD AND PRODUCTION MANAGEMENT SYSTEM

(71) Applicant: Industrial Technology Research Institute, Hsinchu (TW)

(72) Inventors: I-Chun Sun, Tainan City (TW); Ying-Jung Chen, Tainan City (TW); Yi-Lin Chiang, Tainan City (TW)

(73) Assignee: Industrial Technology Research Institute, Hsinchu (TW)

(21) Appl. No.: 18/622,998

(22) Filed: Mar. 31, 2024

(30) Foreign Application Priority Data
Jan. 5, 2024 (TW) 113100543

(51) Int. Cl. G06Q 10/0631

(52) U.S. Cl. CPC G06Q 10/06316

(57) ABSTRACT

A production scheduling method including: reading work order data and production line status data of each of multiple production lines; identifying a target to-be-scheduled production line according to the production line status data; selecting one or more to-be-scheduled work orders; calculating a production cycle indicator of each of the to-be-scheduled work orders according to a production cycle days, a scheduling date, and a delivery date of the each of the to-be-scheduled work orders; sorting the one or more to-be-scheduled work orders to schedule a first-order target to-be-scheduled work order to the target to-be-scheduled production line for production according to the production cycle indicator, a production process direction, and grade transition cost.

### CROSS-REFERENCE TO RELATED APPLICATION

This application claims the priority benefit of Taiwan application serial no. 113100543, filed on Jan. 5, 2024. The entirety of the above-mentioned patent application is hereby incorporated by reference herein and made a part of this specification.

### BACKGROUND

### Technical Field

This disclosure relates to a scheduling method, and in particular to a production scheduling method and a production management system using the method.

### Description of Related Art

In industries with high material complexity, such as the chemical, pharmaceutical, food, and coating industries, grade transition is cyclical, i.e., grades must be transited by a specific cyclical pattern as much as possible during production to avoid an increase in the grade transition cost (also known as the cost of changeover) due to the large differences in characteristics between products. For example, in the coating industry, the production process sequence for each product on the production line is set by color shade to avoid the cost of cleaning tanks and piping. When an industry is characterized by a grade transition cycle, it is necessary to schedule in advance to anticipate demand. However, early production increases inventory loads and losses due to changes in demand, while delayed production may result in late deliveries due to the inability to start production on time. Based on this, how to consider the delivery date, the changeover cost, and the product cycle days to schedule the work order, to reduce the inventory of the finished product and efficiently absorb the order, is a topic that people in this field are committed to study.

### SUMMARY

One of the exemplary embodiments provides a production scheduling method adapted to a production management system. The production management system includes a management server and a production line end. The production line end includes multiple production lines, and the management server includes a processor and an input/output unit. The method includes the following. Through the processor, work order data and production line status data of the production lines are read. According to the production line status data, a target to-be-scheduled production line in the production lines is identified. According to target production line status data corresponding to the target to-be-scheduled production line and the work order data, one or more to-be-scheduled work orders are selected from one or more work orders corresponding to the work order data. According to a production cycle days, a scheduling date, and a delivery date of the each of the to-be-scheduled work orders, a production cycle indicator of each of the to-be-scheduled work orders is calculated. When the scheduling date is later than the delivery date, the production cycle indicator is set directly to 0. According to the production cycle indicator, a production process direction, and grade transition cost of each of the one or more to-be-scheduled work orders, the one or more to-be-scheduled work orders are sorted to obtain one or more sorted to-be-scheduled work orders. A first-order target to-be-scheduled work order in the one or more sorted to-be-scheduled work orders is scheduled to the target to-be-scheduled production line for production. The input/output unit is instructed to update and display a scheduling result of each of the production lines according to the target to-be-scheduled work order.

One of the exemplary embodiments provides a production management system. The production management system includes a management server, where the management server includes a processor and an input/output unit, and a production line end, where the production line end includes multiple production lines. The processor and the production line end are connected through a network connection, where the processor is configured to execute multiple program modules to implement a production scheduling method. The method includes the following. Work order data and production line status data of the production lines are read. According to the production line status data, a target to-be-scheduled production line in the production lines is identified. According to target production line status data corresponding to the target to-be-scheduled production line and the work order data, one or more to-be-scheduled work orders are selected from one or more work orders corresponding to the work order data. According to a production cycle days, a scheduling date, and a delivery date of the each of the to-be-scheduled work orders, a production cycle indicator of each of the to-be-scheduled work orders is calculated. When the scheduling date is later than the delivery date, the production cycle indicator is set directly to 0. According to the production cycle indicator, a production process direction, and grade transition cost of each of the one or more to-be-scheduled work orders, the one or more to-be-scheduled work orders are sorted to obtain one or more sorted to-be-scheduled work orders. A first-order target to-be-scheduled work order in the one or more sorted to-be-scheduled work orders is scheduled to the target to-be-scheduled production line for production. The input/output unit is instructed to update and display a scheduling result of each of the production lines according to the target to-be-scheduled work order.

Based on the above, the disclosure provides a production scheduling method and a production management system, capable of determining the production cycle indicator, the production process direction, and the grade transition cost of the to-be-scheduled work orders corresponding to a to-be-scheduled production line to sort the to-be-scheduled work orders to schedule the first-order to-be-scheduled work order to the to-be-scheduled production line for production according to the work order data, the product data, the production line status data and the grade transition cost data of each of the production lines. In this way, an optimal to-be-scheduled work order may be selected for the production line to-be-scheduled for production, taking into account the production cycle days, the delivery date, the grade transition cost of each of the to-be-scheduled work order, and production line status of the to-be-scheduled production line, to increase a rate of digestion of the to-be-scheduled work order and to reduce the potential inventory of finished products, which in turn strengthens management performance of the management server and improves the production efficiency of the production lines at the production line end.

To make the aforementioned more comprehensible, several embodiments accompanied by drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 is a block diagram of a production management system according to an embodiment of the disclosure.

FIG. 2A is a schematic diagram of data stored in a storage circuit unit according to an embodiment of the disclosure.

FIG. 2B is a schematic diagram of a database according to an embodiment of the disclosure.

FIG. 3 is an operational flow chart of a production scheduling method according to an embodiment of the disclosure.

FIG. 4A is a schematic diagram of order data according to an embodiment of the disclosure.

FIG. 4B is a schematic diagram of work order data according to an embodiment of the disclosure.

FIG. 5A is a schematic diagram of a production process of a to-be-scheduled production line according to an embodiment of the disclosure.

FIG. 5B is a schematic diagram of production line status data according to an embodiment of the disclosure.

FIG. 6A is a schematic diagram of product data according to an embodiment of the disclosure.

FIG. 6B is a schematic diagram of grade transition cost data according to an embodiment of the disclosure.

FIG. 7A is a schematic diagram of a to-be-scheduled work order according to an embodiment of the disclosure.

FIG. 7B is a schematic diagram of a sorted to-be-scheduled work order according to an embodiment of the disclosure.

### DESCRIPTION OF THE EMBODIMENTS

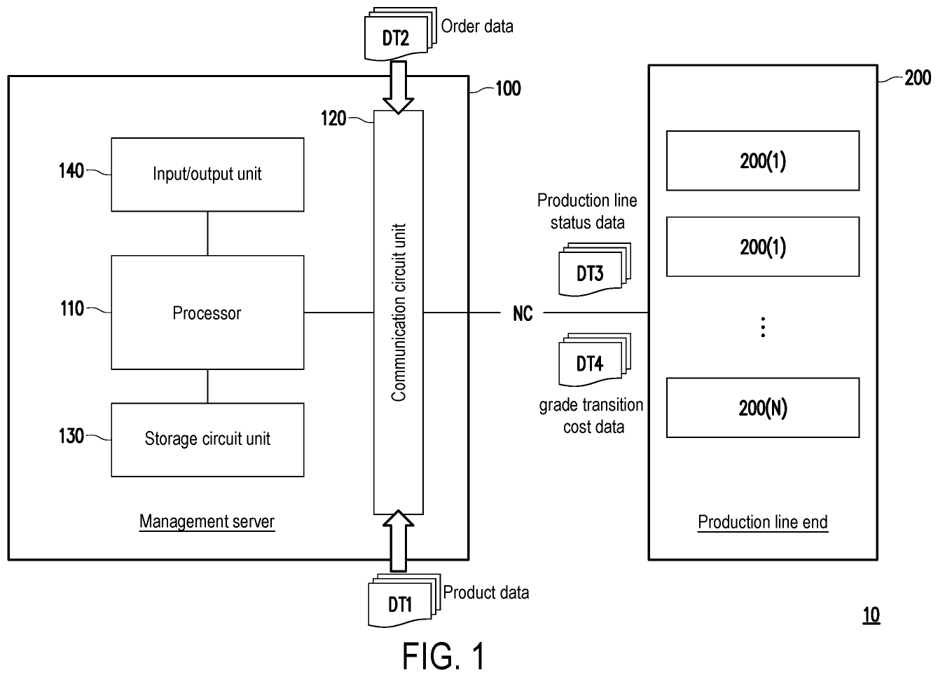

Referring to FIG. 1, in this embodiment, a production management system 10 includes a management server 100 and a production line end 200. A network connection NC is between the management server 100 and the production line end 200. The production line end 200 includes multiple production lines (200(1) to 200(N)). Each of the production lines has one or more production equipment to produce multiple products according to different production processes. In one embodiment, the production line end 200 has one or more production line servers for integrating and monitoring the status of the multiple production lines. The production line end 200 may generate and send production line status data DT3 and grade transition cost data DT4 to the management server 100. For example, the production line server may monitor and record the production status of the each of the production lines, including a production line identification code, a production equipment type owned, a most recently completed (estimated completion) production process sequence, an estimated idle time and date, a product grade, a production process direction, a number of the last operating production station (or production stage), etc.

The management server 100 includes a processor 110, a communication circuit unit 120, a storage circuit unit 130, and an input/output unit 140.

The processor 110 is, for example, a microprogrammed control unit, a central processing unit (CPU), a programmable microprocessor, an application specific integrated circuit (ASIC), a programmable logic device (PLD), or other similar devices.

The communication circuit unit 120 is coupled to the processor 110 and configured to transmit or receive data through wired or wireless communication. In this embodiment, the communication circuit unit may have a wireless communication circuit module (not shown) and support one of the Global System for Mobile Communication (GSM) systems, Personal Handy-phone System (PHS), Code Division Multiple Access (CDMA) system, Wireless Fidelity (WiFi) system, Worldwide Interoperability for Microwave Access (WiMAX) system, different generations of mobile communication technologies (e.g., 3G-6G), Long Term Evolution (LTE), Bluetooth communication technologies, or a combination thereof, and is not limited thereto.

In this embodiment, the management server 100 receives product data DT1 and order data DT2 from other electronic devices/servers through the communication circuit unit 120. In another embodiment, the product data DT1 and order data DT2 may also be obtained through input operations applied to the input/output unit 140.

The storage circuit unit 130 is coupled to the processor 110. The storage circuit unit 130 may store data through instructions from the processor 110. The storage circuit unit includes any type of hard disk drive (HDD) or non-volatile memory storage device (e.g., SSD). In one embodiment, the storage circuit unit further includes a memory for temporarily storing instructions or data executed by the processor, such as a dynamic random access memory (DRAM) and a static random access memory (SRAM).

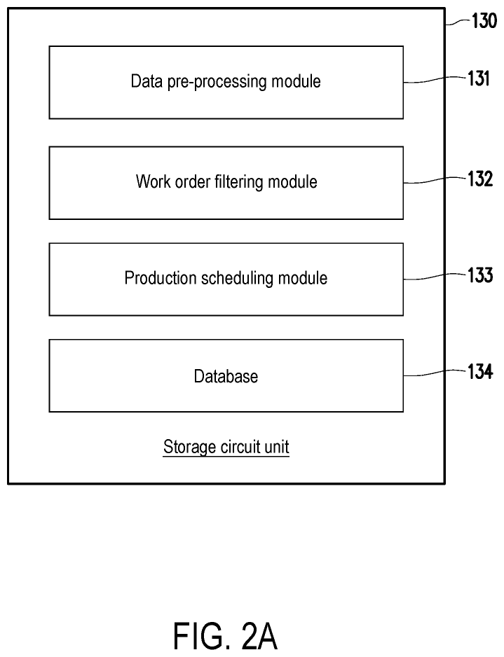

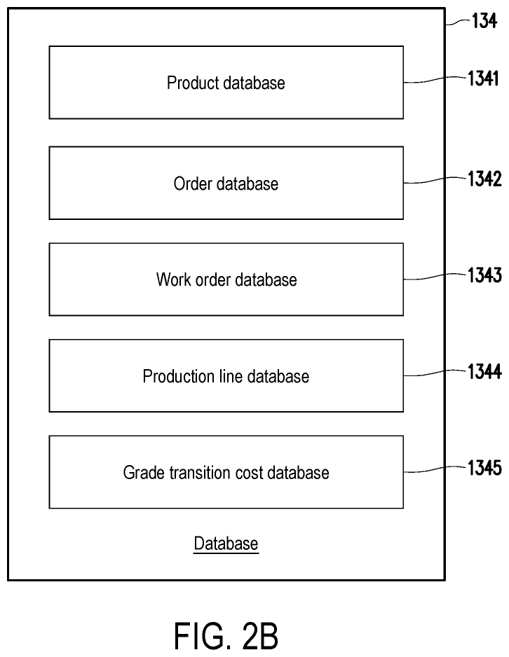

Referring to FIG. 2A, in this embodiment, the storage circuit unit 130 stores multiple program modules, such as a data pre-processing module 131, a work order filtering module 132, a production scheduling module 133, and a database 134. In this embodiment, the data pre-processing module 131 is configured to generate one or more work order data according to one or more orders received (by reading the order data).

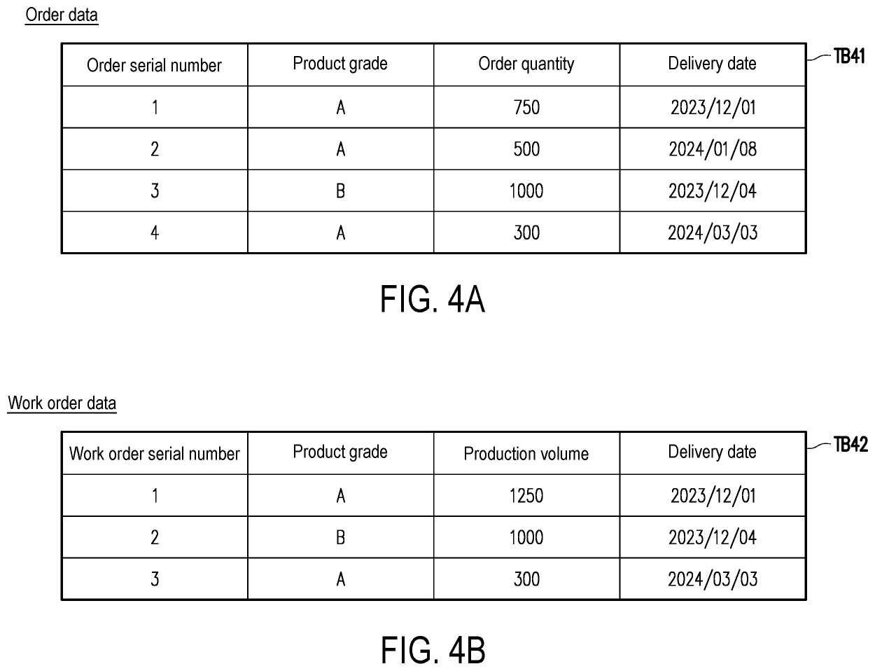

For example, referring to FIG. 4A and FIG. 4B, assuming that the order data of multiple orders received is as shown in table TB41, the data pre-processing module 131 may combine orders of the same product (or category) with similar delivery dates (a threshold value for the number of days between deliveries may be set) into one work order according to the order data, and then form the work order data as shown in Table TB42. Products that have been overproduced are temporarily in stock. However, in another embodiment, an order for one product may be split into multiple work orders and assigned to multiple production lines to increase efficiency. In one embodiment, the data pre-processing module 131 may generate work orders by splitting or combining orders according to a minimum batch size parameter in received parameter data.

Referring to FIG. 2B, the database 134 includes multiple sub-databases, such as a product database 1341, an order database 1342, a work order database 1343, a production line database 1344, and a grade transition cost database 1345. The product database 1341 is used to, for example, store product data. The order database 1342 is used, for example, to store order data. The work order database 1343 is used, for example, to store work order data. The production line database 1344 used is, for example, to store production line status data. The grade transition cost database 1345 is, for example, used to store grade transition cost data. The grade transition cost includes line changeover time and intermediate product output. In one embodiment, the grade transition cost needs to be obtained by querying the grade transition cost data.

The work order data at least includes a work order serial number, a product category, a production volume, and a delivery date (see table TB42 in FIG. 4B).

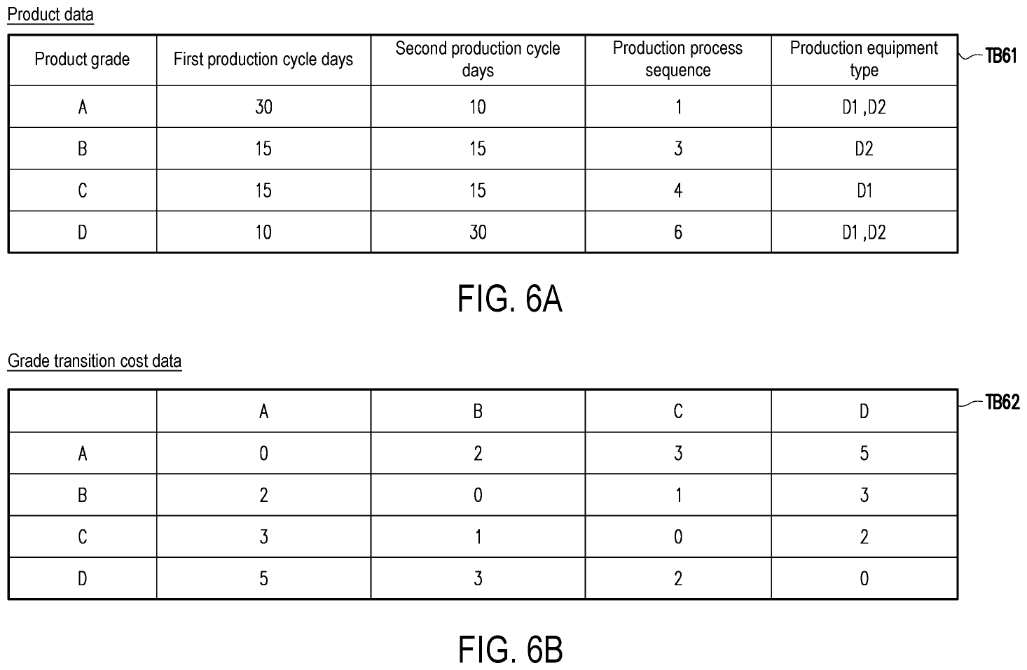

The product data at least includes multiple product grades, a first production cycle days of each of the product grades corresponding to a first production process direction, a second production cycle days of the each of the product grades corresponding to a second production process direction, production process sequence of the each of the product grades, and a production equipment type of the each of the product grades (see table TB61 in FIG. 6A). The production process sequence of products produced sequentially by a production line of the first production process direction is increasing; the production process sequence of products produced sequentially by a production line of the second production process direction is decreasing.

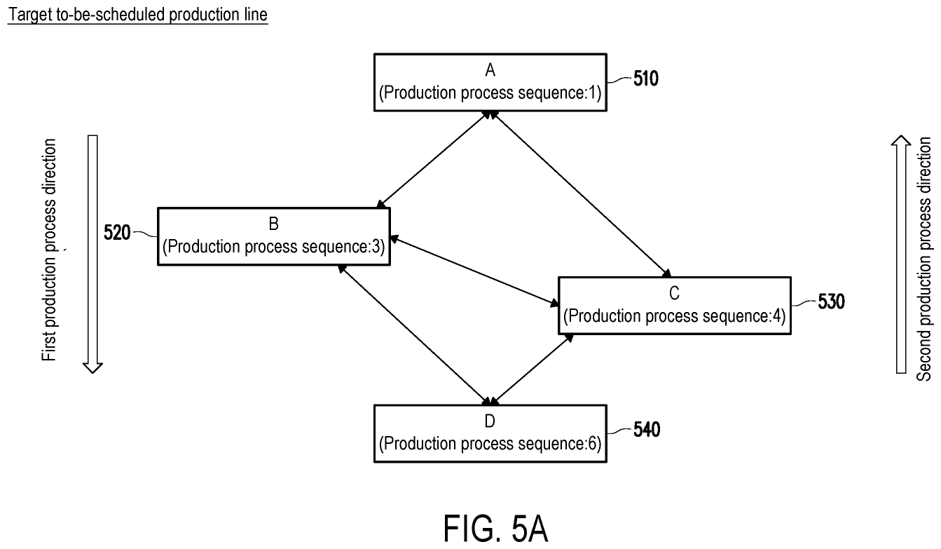

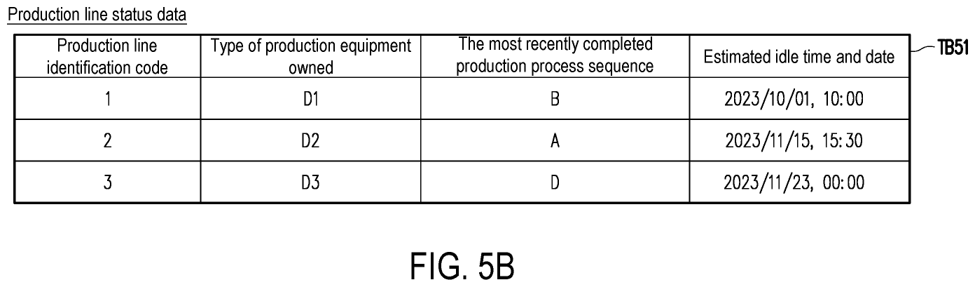

In the case of a production process on a production line for certain types of products, each production line may produce products with different characteristics, and depending on the differences in these characteristics, the production line may be designed to sequentially produce the corresponding products in a production sequence that corresponds to the characteristics of the products, to minimize the production of by-products (lowering the grade transition cost) or/and to increase efficiency. Thus, as shown in FIG. 5A, each production station or production stage (hereinafter, for illustration purposes, the term “production station” is used to denote the production station or production stage of a production line, i.e., “production station” may also be replaced by “production stage”) of a production line is pre-set with the corresponding products and production process sequence, so as to allow the production line to sequentially produce the products of each production station/production stage by using the corresponding first production process direction or the second production process direction. In one embodiment, these production process sequences may exactly correspond to the magnitude of characteristic values of the products to be produced. These characteristic values are, for example, material properties (such as temperature, paint color, melt index, and other material properties). The production management system 10 further includes multiple sensors for detecting the material characteristics of each product. In addition, the production cycle days corresponding to different characteristics refer to: based on material characteristics, in different directions of the production process, such as temperature rise and fall, color change, melt index rise, and fall, the time (number of days) in the production cycle for each product will be different because the product is located at different production stations under a grade transition cycle. The time (e.g., also referred to as production cycle days) in the production cycle of a product means that the product is expected to be scheduled for production again after a certain period has elapsed since the completion of the current production, and the certain period of time elapsed is the time in the production cycle.

The production line status data at least includes a production line identification code, a production equipment type owned, the production process sequence of a most recently completed product category, a current production process direction, and an estimated idle time and date (see table TB51 in FIG. 5B). The server responsible for managing each production line may estimate the completion time of the product being produced and record the corresponding production process sequence of the product as “recently completed production process sequence” for comparison with the production process sequence of the subsequent product to determine the direction of the corresponding production process.

The input/output unit 140 may be further divided into an input device and an output device. In general, common input devices such as mice, keyboards, touchpads, and touch panels are used to allow users to input data or to control the management server 100 through a data input device. The output device is, for example, a display or other device. In one embodiment, the input/output unit 140 further includes a touch display through an integrated touch panel and display.

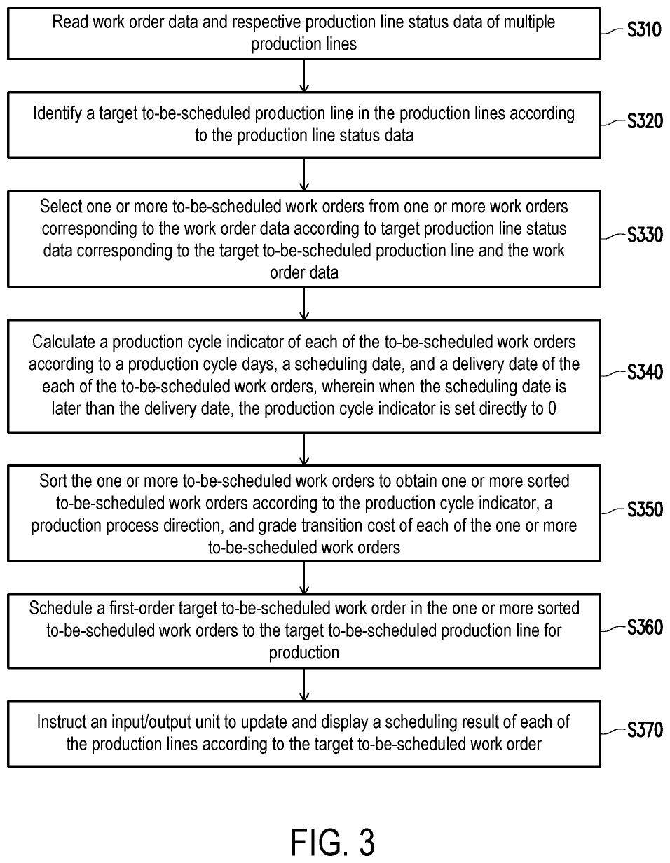

Referring to FIG. 3, in step S310, the processor 110 reads work order data and respective production line status data of the production lines. Next, in step S320, the processor 110 identifies a target to-be-scheduled production line in the production lines according to the production line status data.

Next, in step S330, the processor 110 selects one or more to-be-scheduled work orders from one or more work orders corresponding to the work order data according to target production line status data corresponding to the target to-be-scheduled production line and the work order data. Next, in step S340, the processor 110 calculates a production cycle indicator of each of the to-be-scheduled work orders according to a production cycle days, a scheduling date, and a delivery date of the each of the to-be-scheduled work orders. When the scheduling date is later than the delivery date, the production cycle indicator is set directly to 0.

Next, in step S350, the processor 110 sorts the one or more to-be-scheduled work orders to obtain one or more sorted to-be-scheduled work orders according to the production cycle indicator, a production process direction, and grade transition cost of each of the one or more to-be-scheduled work orders.

Next, in step S360, the processor 110 schedules a first-order target to-be-scheduled work order in the one or more sorted to-be-scheduled work orders to the target to-be-scheduled production line for production. Next, in step S370, the processor 110 instructs the input/output unit to update and display a scheduling result of each of the production lines according to the target to-be-scheduled work order.

The details of steps S320 to S370 will be further described below using multiple embodiments and corresponding drawings.

In one embodiment, the processor 110 further reads product data and respective grade transition cost data of the production lines from the database 134, and identifies the respective product category of the one or more to-be-scheduled work orders.

In one embodiment, the processor 110 selects a production line with the closest estimated idle time and date to the current time as the target to-be-scheduled production line according to the respective production line status data of the production lines. In addition, in one embodiment, the processor 110 may select a production line with the highest production efficiency as the target to-be-scheduled production line from multiple idle production lines or select a production line with the longest or shortest idle time as the target to-be-scheduled production line.

In one embodiment, the processor 110 selects one or more to-be-scheduled work orders from one or more work orders corresponding to the work order data according to target production line status data corresponding to the target to-be-scheduled production line and the work order data, and identifies the respective product category of the one or more to-be-scheduled work orders.

Specifically, the processor 110 selects one or more to-be-scheduled work orders from one or more work orders corresponding to the work order data according to the production equipment type owned of the target production line status data of the target to-be-scheduled production line. The production equipment type corresponding to the respective product grade of the one or more to-be-scheduled work orders matches the production equipment type owned by the target to-be-scheduled production line. For example, it is assumed that the two products to be scheduled are product A and product B, and the types of production equipment for the product A are equipment D1 and equipment D2, and the types of production equipment for the product B is equipment D2. If the production equipment type owned by the target to-be-scheduled production line is equipment D2, the processor 110 selects the work orders corresponding to the product A and the product B as the to-be-scheduled work order (because the product grades of these work orders can be produced by equipment D2 of the target to-be-scheduled production line). For example, if the production equipment type owned by another target to-be-scheduled production line is equipment D1, the processor 110 selects the work order corresponding to the product A as the to-be-scheduled work order.

In one embodiment, the processor 110 determines the respective production process direction, which corresponds to the target to-be-scheduled production line, of the each of the one or more to-be-scheduled work orders according to the target production line status data, the product data, and the product grade of the each of the to-be-scheduled work orders.

Specifically, the processor 110 identifies the production process sequence (also known as a first production process sequence) corresponding to one of the product grades (also known as a first product grade) of one or more to-be-scheduled work orders (also known as a first to-be-scheduled work order) according to the product grade and the product data; next, the processor 110 identifies the production process sequence (also known as a second production process sequence) of the most recently completed product grade of the target to-be-scheduled production line according to the target production line status data. In response to the first production process sequence not earlier than the second production process sequence, the processor 110 determines that the production process direction, corresponding to the target to-be-scheduled production line, of the first to-be-scheduled work order target to-be-scheduled production line is the first production process direction. On the contrary, in response to the first production process sequence being earlier than the second production process sequence, the processor 110 determines that the production process direction, corresponding to the target to-be-scheduled production line, of the first to-be-scheduled work order target to-be-scheduled production line is the second production process direction.

For example, referring to FIG. 5A, it is assumed that the target to-be-scheduled production line has 4 production stations (or production stages) 510 to 540. In addition, the target to-be-scheduled production line has been pre-planned according to the capabilities of the production equipment and the characteristics of the products produced: when the target to-be-scheduled production line is at the production station 510, the target to-be-scheduled production line is used to produce the product A, and the corresponding production process sequence thereof is, for example, 1; when the target to-be-scheduled production line is at the production station 520, the target to-be-scheduled production line is used to produce the product B, and the corresponding production process sequence thereof is, for example, 3; when the target to-be-scheduled production line is at the production station 530, the target to-be-scheduled production line is used to produce a product C, and the corresponding production process sequence thereof is, for example, 4; when the target to-be-scheduled production line is at the production station 540, the target to-be-scheduled production line is used to produce a product D, and the corresponding production process sequence thereof is, for example, 6.

When the current production process direction of the target to-be-scheduled production line is the first production process direction, the target to-be-scheduled production line may produce product A, product B, product C, and product D in sequence, or produce product A, product B, and product D in sequence, or produce product A, product C, and product D in sequence according to the production process sequence of the products at each production station. On the contrary, when the current production process direction of the target to-be-scheduled production line is the second production process direction, the target to-be-scheduled production line may produce product D, product C, product B, and product A in sequence, or produce product D, product C, and product A in sequence, or produce product D, product B, and product A in sequence according to the production process sequence of the products at each production station.

It should be noted that, in one embodiment, after the production at the final production station 540 has been completed on the production line in the first production process direction, the production line may be adjusted to the second production process direction to enter the production station 520 or 530 for the production of products B or C. On the contrary, after the production at the final production station 510 has been completed on the production line in the second production process direction, the production line may be adjusted to the first production process direction to enter the production station 520 or 530 for the production of products B or C.

For example, it is assumed that the processor 110 identifies that the production process sequence of the most recently completed product grade of the target to-be-scheduled production line is 3 according to the target production line status data, and identifies that the production process sequence of a product grade corresponding to a to-be-scheduled work order is 4. In this case, the processor 110 determines that the production process direction, corresponding to the target to-be-scheduled production line, of the to-be-scheduled work order is the first production process direction (because the production process sequence of the to-be-scheduled work order is not earlier than the most recently completed production process sequence of the target to-be-scheduled production line). For another example, it is assumed that the processor 110 identifies that the production process sequence of the most recently completed product grade of the target to-be-scheduled production line is 6 according to the target production line status data, and identifies that the production process sequence of a product grade corresponding to a to-be-scheduled work order is 3. In this case, the processor 110 determines that the production process direction, corresponding to the target to-be-scheduled production line, of the to-be-scheduled work order is the second production process direction (because the production process sequence of the to-be-scheduled work order is earlier than the most recently completed production process sequence of the target to-be-scheduled production line). That is, the processor 110 may determine, according to the production process sequence of the to-be-scheduled work order and the most recently completed production process sequence of the target production line status data, the product grade to produce the to-be-scheduled work order and a type of production process direction that the target to-be-scheduled production line needs to perform.

In one embodiment, the processor 110 determines the respective production cycle days of the one or more to-be-scheduled work orders according to the product data, the production process direction and the product grade of the each of the to-be-scheduled work orders.

Specifically, the processor 110 determines, through querying the product data, that the production cycle days of the first to-be-scheduled work order are the first production cycle days or the second production cycle days according to the first product grade corresponding to the first to-be-scheduled work order (one of the to-be-scheduled work orders) and the production process direction determined. In response to the production process direction being the first production process direction, the production cycle days of the first to-be-scheduled work order being the first production cycle days is determined. In addition, in response to the production process direction being the second production process direction, the production cycle days of the first to-be-scheduled work order being the second production cycle days is determined.

For example, referring to FIG. 6A, assuming that the product grade of the to-be-scheduled work order is “A”, and the production process direction corresponding to the target to-be-scheduled production line is the first production process direction, the processor 110 identifies the number of production cycle days of this to-be-scheduled work order as the first number of production cycle day “30” according to the product data (as shown in table TB61). For another example, assuming that the product grade of the to-be-scheduled work order is “B”, and the production process direction corresponding to the target to-be-scheduled production line is the second production process direction, the processor 110 identifies the number of production cycle days of this to-be-scheduled work order as the second number of production cycle day “15” according to the product data (as shown in table TB61).

In one embodiment, the processor 110 may calculate the production cycle indicator of the to-be-scheduled work order according to the following formula:

$${I}_{j} ( t ) = \{ \begin{matrix}⌊ \frac{( {d}_{j} - t )}{{τ}_{j}} ⌋ , & if {d}_{j} - t \geq 0 \\ 0 , & if t > {d}_{j}\end{matrix}$$

Iⱼ (t) represents the production cycle indicator (unconditional rounding to integers) of a to-be-scheduled work order j with a scheduling date t; t is the scheduling date that is the date on which the calculation operation is performed by default; dⱼ is the delivery date of the to-be-scheduled work order j; τj is the production cycle days of the to-be-scheduled work order j.

In one embodiment, the processor 110 determines the respective grade transition cost of the one or more to-be-scheduled work orders corresponding to the target to-be-scheduled production line according to the target grade transition cost data of the target to-be-scheduled production line, the target production line status data, and the product grade of the each of the to-be-scheduled work orders.

Specifically, the processor 110 identifies the production process sequence (also known as the first production process sequence) of the first to-be-scheduled work order (one of the to-be-scheduled work orders) through the product data according to the first product grade corresponding to the first to-be-scheduled work order; identifies the production process sequence (also known as the second production process sequence) of the most recently completed product grade of the target to-be-scheduled production line according to the target production line status data; and queries, through the target grade transition cost data, grade transition cost from the second production process sequence (the previous product grade) to the first production process sequence (the product grade to be produced), to be as the grade transition cost of the first to-be-scheduled work order corresponding to the target to-be-scheduled production line according to the first production process sequence and the second production process sequence. For example, as shown in FIG. 6B, it is assumed that the recently completed product grade is B, and the product grade to be produced is C. In this example, the changeover cost may be obtained by querying the grade transition cost data, and the grade transition cost from B to C is 1.

Referring to FIG. 6B, it is assumed that the grade transition cost data corresponding to the target to-be-scheduled production line can be presented through Table TB62. It is assumed that the upper column/left column corresponds to the product grade of the first to-be-scheduled work order, and the left column/upper column corresponds to the most recently completed product grade of the target to-be-scheduled production line. Through querying the grade transition cost data (table TB62), the processor 110 may identify the grade transition cost incurred in transiting the production stations used to produce two product grades. For example, assuming that the product grade of the to-be-scheduled work order is “A” and the most recently completed product grade of the target to-be-scheduled production line is “C”, the processor 110 may identify the corresponding grade transition cost is “3” (which may be regarded as having a grade transition cost of 3 units). For another example, assuming that the product grade of the to-be-scheduled work order is “A” and the most recently completed product grade of the target to-be-scheduled production line is “A”, the processor 110 may identify the corresponding grade transition cost is “0” (that is, the production station does not need to be replaced, and there is no grade transition cost).

In one embodiment, the processor 110 sorts the one or more to-be-scheduled work orders to obtain one or more sorted to-be-scheduled work orders according to the production cycle indicator, the production process direction, and the grade transition cost of each of the one or more to-be-scheduled work orders.

Specifically, the processor 110 sorts the to-be-scheduled work orders in ascending order according to the respective production cycle indicator of the to-be-scheduled work orders; for multiple second to-be-scheduled work orders having the same production cycle indicator, through determining a matching result (if matched, the matching result of the corresponding production direction is determined to be “1”; if there is no match, the matching result of the corresponding production direction is determined to be “0”) of the respective production process direction of the second to-be-scheduled work orders and the current production process direction of the target to-be-scheduled production line, sorts the matched one or more of the second to-be-scheduled work orders to the front; for multiple third to-be-scheduled work orders having the same production cycle indicator and the same production process direction, sorts the third to-be-scheduled work orders in ascending order according to the respective grade transition cost of the third to-be-scheduled work orders; and for multiple fourth to-be-scheduled work orders having the same production cycle indicator, the same production process direction and the grade transition cost, sorts in ascending order or randomly sorts the fourth to-be-scheduled work orders according to a work order serial number of the fourth to-be-scheduled work orders or the delivery date.

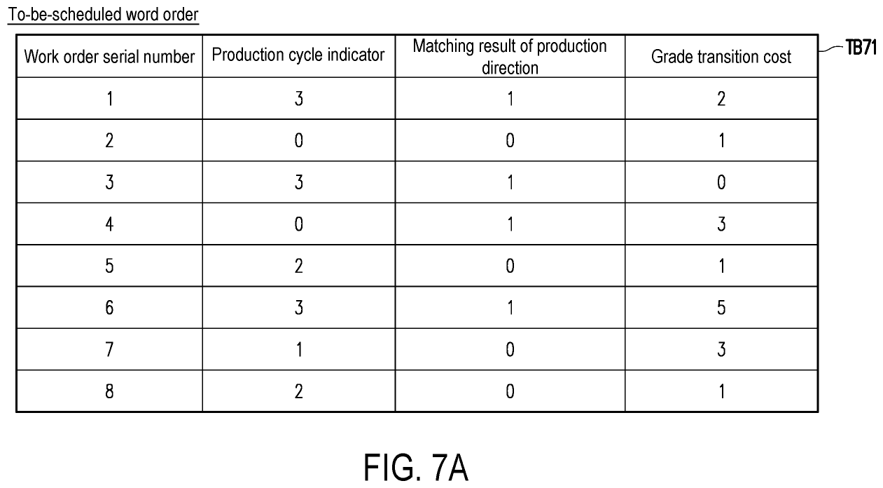

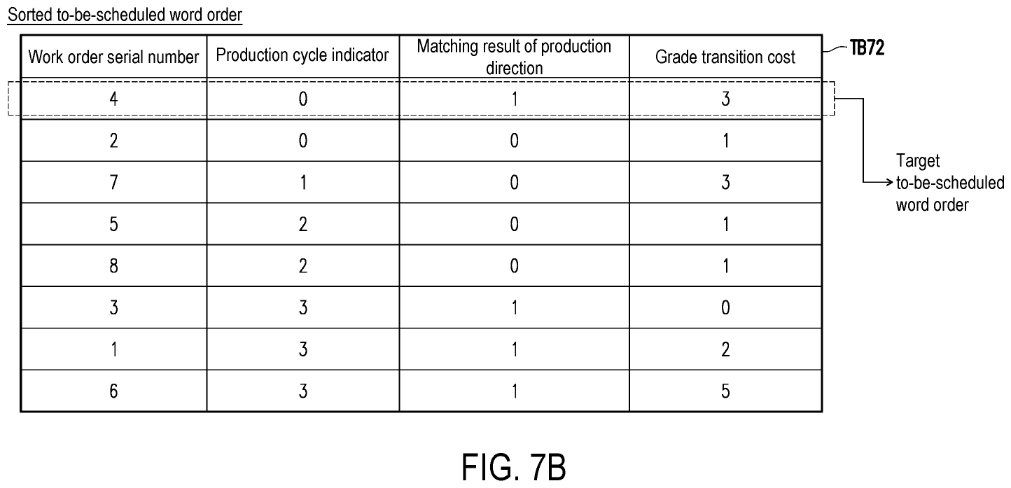

Referring to FIG. 7A and FIG. 7B, assuming that after obtaining the matching result (also known as the matching result of production direction) of the respective production process direction of the to-be-scheduled work order and the current production process direction of the target to-be-scheduled production line, the processor 110 obtains the production cycle indicator, the matching result of production direction, and the grade transition cost of multiple to-be-scheduled work orders (work order serial number 1 to 8), which can be presented using, for example, the table TB71. After executing step S380, the processor 110 obtains multiple sorted to-be-scheduled work orders in the order from first to last of the work order serial numbers 4, 2, 7, 5, 8, 3, 1, and 6, which may be presented using, for example, the table TB72.

As shown in table TB72, the to-be-scheduled work orders will first be sorted according to the production cycle indicator. If there are the same production cycle indicator, then the to-be-scheduled work orders are sorted according to the matching result of production direction, so that the to-be-scheduled work orders matching the target to-be-scheduled production line are sorted in the front (for example, the examples of the work order serial numbers 2 and 4). If there are the same production cycle indicator and the same matching result of production direction, then the to-be-scheduled work orders are sorted in ascending order according to the grade transition cost (for example, the examples of the work order serial numbers 3, 1, and 6). If there are the same production cycle indicator, the same matching result of production direction, and the same grade transition cost, then the to-be-scheduled work orders are sorted in ascending order according to the work order serial numbers (for example, the examples of the work order serial numbers 5 and 8).

In one embodiment, after obtaining the one or more sorted to-be-scheduled work orders, the processor 110 schedules the first-order target to-be-scheduled work order in the one or more sorted to-be-scheduled work orders to the target to-be-scheduled production line for production.

For example, in the example of table TB72, after the sorting is completed, the processor 110 selects the first-order to-be-scheduled work order (for example, the to-be-scheduled work order with a work order serial number 4). It schedules the selected target to-be-scheduled work order to the target to-be-scheduled production line for production.

In one embodiment, after scheduling the target to-be-scheduled work order, the processor 110 updates and displays the scheduling result of each production line according to the target-to-be-scheduled work order. The processor 110 may instruct the input/output unit to display the latest scheduling result. The scheduling result may be displayed in one or more of the following ways: tables, Gantt charts, graphs, or charts, and contain at least the scheduling data of priority of all scheduled work orders on each production line.

In one embodiment, after scheduling the first-order target to-be-scheduled work order in the one or more sorted to-be-scheduled work orders to the target to-be-scheduled production line for production, the process 110 identifies a new target to-be-scheduled production line from other production lines of the production lines (S320), removes the target to-be-scheduled work order from the one or more to-be-scheduled work orders to update the work order data, selects one or more new to-be-scheduled work orders according to the work order data updated (S330), and performs the subsequent steps (i.e., perform the above step S340 to S370 again).

It should be noted that step S310 may be executed periodically or after step S350 or S360 is executed. If there is no to-be-scheduled work order, return to step S320 to select the next production line that can be scheduled as the to-be-scheduled production line.

It should be noted that the scenarios assumed in the above examples and tables are only illustrative, and the disclosure is not limited thereto.

Based on the above, the disclosure provides a production scheduling method and a production management system, capable of determining the production cycle indicator, the production process direction, and the grade transition cost of the to-be-scheduled work orders corresponding to a to-be-scheduled production line to sort the to-be-scheduled work orders to schedule the first-order to-be-scheduled work order to the to-be-scheduled production line for production according to the work order data, the product data, the respective production line status data and the grade transition cost data of the production lines. In this way, an optimal to-be-scheduled work order may be selected for the production line to-be-scheduled for production, taking into account the production cycle days, the delivery date, the grade transition cost of each of the to-be-scheduled work order, and production line status of the to-be-scheduled production line, to increase a rate of digestion of the to-be-scheduled work order and to reduce the potential inventory of finished products, which in turn strengthens management performance of the management server and improves the production efficiency of the production lines at the production line end.

It will be apparent to those skilled in the art that various modifications and variations can be made to the disclosed embodiments without departing from the scope or spirit of the disclosure. Given the foregoing, it is intended that the disclosure covers modifications and variations provided that they fall within the scope of the following claims and their equivalents.

What is claimed is:

1. A production scheduling method, adapted to a production management system, wherein the production management system comprises a management server and a production line end, wherein the production line end comprises a plurality of production lines, the management server comprises a processor and an input/output unit, and the method comprises:
through the processor configured to:
read work order data and production line status data of each of the production lines;
identify a target to-be-scheduled production line in the production lines according to the production line status data;
select one or more to-be-scheduled work orders from one or more work orders corresponding to the work order data according to target production line status data corresponding to the target to-be-scheduled production line and the work order data;
calculate a production cycle indicator of each of the to-be-scheduled work orders according to a production cycle day, a scheduling date, and a delivery date of the each of the to-be-scheduled work orders, wherein when the scheduling date is later than the delivery date, the production cycle indicator is set directly to 0;
sort the one or more to-be-scheduled work orders to obtain one or more sorted to-be-scheduled work orders according to the production cycle indicator, a production process direction, and grade transition cost of each of the one or more to-be-scheduled work orders;
schedule a first-order target to-be-scheduled work order in the one or more sorted to-be-scheduled work orders to the target to-be-scheduled production line for production; and
instruct the input/output unit to update and display a scheduling result of each of the production lines according to the target to-be-scheduled work order.

2. The production scheduling method according to claim 1, wherein the work order data at least comprises:
a work order serial number;
a product grade;
a production volume; and
a delivery date.

3. The production scheduling method according to claim 2, the method further comprising:
reading product data and grade transition cost data of each of the production lines;
identifying a product grade of each of the one or more to-be-scheduled work orders;
determining the production process direction, corresponding to the target to-be-scheduled production line, of the each of the one or more to-be-scheduled work orders according to the target production line status data, the product data, and the product grade of the each of the to-be-scheduled work orders;
determining the production cycle days of each of the one or more to-be-scheduled work orders according to the product data, the production process direction and the product grade of the each of the to-be-scheduled work orders.

4. The production scheduling method according to claim 3, the method further comprising:
determining the grade transition cost of each of the one or more to-be-scheduled work orders corresponding to the target to-be-scheduled production line according to target grade transition cost data of the target to-be-scheduled production line, the target production line status data, and the product grade of the each of the to-be-scheduled work orders.

5. The production scheduling method according to claim 3, wherein the product data at least comprises:
a plurality of product grades;
a first production cycle days of each of the product grades corresponding to a first production process direction, wherein production process sequence of products produced sequentially by a production line of the first production process direction is increasing;
a second production cycle days of the each of the product grades corresponding to a second production process direction, wherein the production process sequence of products produced sequentially by a production line of the second production process direction is decreasing;
production process sequence of the each of the product grades; and
a production equipment type for the each of the product grades.

6. The production scheduling method according to claim 5, wherein each of the production line status data at least comprises:
a production line identification code;
a production equipment type owned;
production process sequence of a most recently completed product grade;
a current production process direction; and
an estimated idle time and date.

7. The production scheduling method according to claim 6, wherein selecting one or more to-be-scheduled work orders from one or more work orders corresponding to the work order data according to target production line status data corresponding to the target to-be-scheduled production line and the work order data comprises:
selecting one or more to-be-scheduled work orders from one or more work orders corresponding to the work order data according to the production equipment type owned of the target production line status data of the target to-be-scheduled production line, wherein the production equipment type corresponding to the product grade of each of the one or more to-be-scheduled work orders matches the production equipment type owned of the target to-be-scheduled production line.

8. The production scheduling method according to claim 7, wherein determining the production process direction, corresponding to the target to-be-scheduled production line, of the each of the one or more to-be-scheduled work orders according to the target production line status data, the product data, and the product grade of the each of the to-be-scheduled work orders comprises:
identifying first production process sequence corresponding to a first product grade of a first to-be-scheduled work order according to the product grade and the product data;
identifying second production process sequence of the most recently completed product grade of the target to-be-scheduled production line according to the target production line status data;
if the first production process sequence is not earlier than the second production process sequence, determining that the production process direction of the first to-be-scheduled work order corresponding to the target to-be-scheduled production line is the first production process direction; and
if the first production process sequence is earlier than the second production process sequence, determining that the production process direction of the first to-be-scheduled work order corresponding to the target to-be-scheduled production line is the second production process direction.

9. The production scheduling method according to claim 8, wherein determining the production cycle days of the one or more to-be-scheduled work orders according to the product data, the production process direction and the product grade of the each of the to-be-scheduled work orders comprises:
determining, through querying the product data, whether the production cycle days of the first to-be-scheduled work order are the first production cycle days or the second production cycle days according to the first product grade corresponding to the first to-be-scheduled work order and the production process direction determined,
wherein when the production process direction is the first production process direction, determining that the production cycle days of the first to-be-scheduled work order is the first production cycle days,
wherein when the production process direction is the second production process direction, determining that the production cycle days of the first to-be-scheduled work order is the second production cycle days.

10. The production scheduling method according to claim 9, wherein determining the respective grade transition cost of the one or more to-be-scheduled work orders corresponding to the target to-be-scheduled production line according to the target grade transition cost data of the target to-be-scheduled production line, the target production line status data, and the product grade of the each of the to-be-scheduled work orders comprises:
identifying a first production process sequence of the first to-be-scheduled work order through the product data according to the first product grade corresponding to the first to-be-scheduled work order according to the first product grade corresponding to the first to-be-scheduled work order;
identifying a second production process sequence of the most recently completed product grade of the target to-be-scheduled production line according to the target production line status data; and
querying, through the target grade transition cost data, grade transition cost for transiting from the second production process sequence to the first production process sequence, to be as the grade transition cost of the first to-be-scheduled work order corresponding to the target to-be-scheduled production line according to the first production process sequence and the second production process sequence.

11. The production scheduling method according to claim 1, wherein sorting the one or more to-be-scheduled work orders to obtain the one or more sorted to-be-scheduled work orders according to the production cycle indicator, the production process direction, and the grade transition cost of the each of the one or more to-be-scheduled work orders comprises:
sorting the to-be-scheduled work orders in ascending order according to the production cycle indicator of each of the to-be-scheduled work orders;
for a plurality of second to-be-scheduled work orders having the same production cycle indicator, through determining a matching result of the production process direction of each of the second to-be-scheduled work orders and the current production process direction of the target to-be-scheduled production line, sorting the matched one or more of the second to-be-scheduled work orders to the front;
for a plurality of third to-be-scheduled work orders having the same production cycle indicator and the same production process direction, sorting the third to-be-scheduled work orders in ascending order according to the grade transition cost of each of the third to-be-scheduled work orders; and
for a plurality of fourth to-be-scheduled work orders having the same production cycle indicator, the same production process direction and the same grade transition cost, sorting the fourth to-be-scheduled work orders in ascending order or randomly according to a work order serial number or the delivery date of the fourth to-be-scheduled work orders.

12. The production scheduling method according to claim 1 further comprising:
generating, through execution of a data pre-processing module by the management server, the one or more work order data according to one or more orders received.

13. The production scheduling method according to claim 1, wherein each of the grade transition cost data comprises production cost incurred in transiting from production of the first product grade to production of the second product grade on the target to-be-scheduled production line.

14. The production scheduling method according to claim 1, wherein identifying the target to-be-scheduled production line in the production lines comprises:
selecting a production line with the closest estimated idle time and date to the current time as the target to-be-scheduled production line according to the production line status data of each of the production lines.

15. The production scheduling method according to claim 1, wherein after scheduling the first-order target to-be-scheduled work order in the one or more sorted to-be-scheduled work orders to the target to-be-scheduled production line for production, the method further comprises:
identifying a new target to-be-scheduled production line from other production lines of the production lines;
removing the target to-be-scheduled work order from the one or more to-be-scheduled work orders to update the work order data; and
selecting one or more new to-be-scheduled work orders according to the work order data updated, and performing the follow-up.

16. The production scheduling method according to claim 1, wherein calculating the production cycle indicator according to the production cycle days of the each of the to-be-scheduled work orders, the scheduling date, and the delivery date further comprises using the following formula:
$${I}_{j} ( t ) = \{ \begin{matrix}⌊ \frac{( {d}_{j} - t )}{{τ}_{j}} ⌋ , & if {d}_{j} - t \geq 0 \\ 0 , & if t > {d}_{j}\end{matrix}$$
where Iⱼ(t) represents the production cycle indicator of a to-be-scheduled work order j with a scheduling date t; t is the scheduling date that is the date on which the calculation operation is performed by default; dⱼ is the delivery date of the to-be-scheduled work order j; τⱼ is the production cycle days of the to-be-scheduled work order j.

17. A production management system, comprising:
a management server, wherein the management server comprises a processor and an input/output unit; and
a production line end, wherein the production line end comprises a plurality of production lines, wherein the processor and the production line end are connected through a network connection, wherein the processor is configured to execute a plurality of program modules to implement a production scheduling method, and the method comprises:
reading work order data and production line status data of each of the production lines;
identifying a target to-be-scheduled production line in the production lines according to the production line status data;
selecting one or more to-be-scheduled work orders from one or more work orders corresponding to the work order data according to target production line status data corresponding to the target to-be-scheduled production line and the work order data;
calculating a production cycle indicator of each of the to-be-scheduled work orders according to a production cycle day, a scheduling date, and a delivery date of the each of the to-be-scheduled work orders, wherein when the scheduling date is later than the delivery date, the production cycle indicator is set directly to 0;
sorting the one or more to-be-scheduled work orders to obtain one or more sorted to-be-scheduled work orders according to the production cycle indicator, a production process direction, and grade transition cost of each of the one or more to-be-scheduled work orders;
scheduling a first-order target to-be-scheduled work order in the one or more sorted to-be-scheduled work orders to the target to-be-scheduled production line for production; and
instructing the input/output unit to update and display a scheduling result of each of the production lines according to the target to-be-scheduled work order.
